(19) United States
(12) Patent Application Publication
(10) Pub. No.: US 2015/0001984 A1
(43) Pub. Date: Jan. 1, 2015

(54) IN-SLOT STATOR WINDING COMPACTION

(71) Applicant: Remy Technologies, LLC, Pendleton, IN (US)

(72) Inventor: Michael D. Bradfield, Anderson, IN (US)

(21) Appl. No.: 13/931,605

(22) Filed: Jun. 28, 2013

(51) Int. Cl. H02K 15/02; H02K 1/16

(52) U.S. Cl. CPC H02K 15/024; H02K 1/165
USPC 310/216.069; 29/596

(57) ABSTRACT

A method of manufacturing a stator assembly for an electrical machine, including the steps of: arranging a plurality of elongate wire segments in single file along the depth of a stator slot located between opposing walls of a pair of adjacent stator core teeth; compressing the wire segments substantially in a direction of the stator slot depth, whereby the wire segments are compacted into the stator slot; plastically deforming at least one of the wire segments, whereby a cross-section of the plastically deformed wire segment is expanded in a direction along which the opposing tooth walls are spaced from each other; and deforming the tip of at least one of the pair of adjacent stator core teeth to at least partially close up the stator slot upon the compressed wire segments and further compacting the wire segments into the stator slot.

### BACKGROUND

The present disclosure relates to rotary electric machines such as electric motors or generators, particularly of the polyphase type, and, more particularly, to methods and systems for manufacturing multiple-pole stator assemblies used therein, and the stator assemblies themselves.

Rotary electric machines operate by exploiting the interaction of the relatively rotating magnetic fields of a rotor and a stator, the rotor disposed within and rotatable relative to the stator. The rotor is typically fixed to a shaft mounted for rotation centrally by means of bearings in a casing that surrounds the stator. These machines include a configuration of insulated wire coils or windings in the stator, which are distributed about the stator central axis, the windings typically arranged in a progressive sequence to define different electrical phases. The stator windings are typically wound around ferromagnetic poles of the stator core to enhance the strength of the stator's magnetic field. The stator poles generally are tooth-like cross sections that are usually rectangular or trapezoidal, and typically defined by slots in the stator core.

In a polyphase electric motor, flowing current of different phases through a progressive sequence of wire windings in the stator generates rotating magnetic fields in the stator, which impart electromechanical torque to the rotor and its shaft. Conversely, in a polyphase electric generator or alternator, externally forced rotation of the shaft and rotor imparts rotation to magnetic fields that induce current flows in the stator windings.

As is well-known in the relevant art, the stator core may be formed by a stack of interlocked, ferrous laminae, typically formed from electrical sheet steel, each lamina having a central hole, the holes being aligned in the lamina stack to form a stator core central bore having a central axis. Thus, the stator core may be a unitary annular member, its central bore defining a radially internal bore face that is generally cylindrical and centered about the central axis. The radially internal bore face is provided with the generally axially extending, elongate slots formed by aligned, notched portions of the lamina holes that define the stator poles. The stator slots pass axially through the lamina stack adjacent the central bore since they extend over the entire axial length of the lamina stack and are open radially on an internal side and the two opposite axial ends. The slots formed by the lamina stack may lie in planes that intersect along and contain the stator central axis, but are sometimes inclined with respect to that axis. It may nevertheless be said that the stator core slots are generally parallel with the stator central axis. The plurality of stator slots is typically distributed at an even pitch about the stator central axis. Relative to the stator, radial and axial directions mentioned herein are respective to the stator central axis, and the stator slots generally extend radially from the central bore face into the stator core and axially along the bore length. Thus, each stator core slot has a generally axial length dimension extending along the length of the stator core bore, a width dimension extending circumferentially about the central axis between a pair of adjacent stator core teeth, and a radial depth dimension extending between the slot opening proximate the stator core central bore and the slot bottom.

Disposed in and extending along these stator slots are elongate electrical conductors that define the stator coil windings. By virtue of the conductors being routed through the stator slots, they are wrapped about the stator poles. Typically, a stator slot insulator insert is located between the conductors and the walls of the stator slots to ensure electrical isolation of the stator windings from the stator core. Typically, the insulator insert is formed of a flexible, electrically insulative sheet material such as a plastic that is inserted into the slot before a conductor is installed therein, the sheet material forming an electrically insulative layer between the conductors and their respective stator slot.

Thus, a typical stator assembly includes an annular stator core, a stator winding constituted by a number of electrical conductors, segments or lengths of which are disposed inside slots formed in the stator core, and inserted insulators providing electrical insulation between the stator core and the electrical conductor segments.

In a polyphase rotary electric machine, the stator coil windings include a plurality (typically three or a multiple thereof) of different phase windings each formed of elongate electrical conductor material such as a copper magnet wire or bar. The conductor cross-section is typically circular or rectangular (including square), or oval. Round wire of conventional sizes may be used for the conductors; optionally, thick bar conductors can be used for making a wire coil with a designed current-carrying capacity requiring fewer turns than is possible with smaller sized round wire.

Each stator slot may accommodate multiple, small diameter wire segments that are wound in bulk and rather randomly oriented and located, and typically cross over each other, within the slot. Examples of such windings are ubiquitous and well-known to those having ordinary skill in the relevant art. Alternatively, the stator slots may have a depth and/or width that is a multiple of the cross-sectional dimension of the conductor, in the slot's radial and/or circumferential direction. In the example of a three-phase stator, multiple electrical conductor segments may be housed within each of the stator slots, and the electrical conductors arranged in a predetermined winding pattern to form the stator winding. The particular winding patterns of stator windings can vary considerably between different machine designs.

It is well known in the art that increasing the fill of a conductor material in a stator slot improves both the performance and efficiency of an electrical machine. This is often accomplished through the use of rectangular magnet wire that is bent into hairpin shapes and axially inserted into the stator core slots. Thus, each electrical phase winding includes a plurality of individual, formed conductors inserted into the start slots, with the open ends of the conductors then welded to the appropriate neighboring conductor to complete the winding. Such a winding is very effective in increasing the slot fill and achieving the benefits that come from it. However, such a process is expensive from both a piece cost and tooling investment standpoint. Currently, the cost of round copper magnet wire is approximately $8 per kilogram, whereas that of rectangular wire is approximately $13 per kilogram.

Heretofore, conventional fly-winding techniques, which are well known in the art and accommodate the relatively cheaper round magnet wire, have not yielded a comparable slot fill vis-à-vis hairpin windings of rectangular magnet wire. Conventional fly-winding techniques vary, but generally involve a continuous length of round wire being unspooled from a supply reel and wrapped about the stator poles directly or, alternatively, inserted into the stator core slots through use of an intermediate tool, of which there are numerous different known types. According to one non-limiting example, the round wires are wound onto a cylindrical dummy rotor or magazine, with the windings disposed in radially extending magazine slots. The magazine is then placed within the stator central bore, and the windings carried by the magazine are then ejected radially outwardly from the magazine slots and inserted into the correspondingly aligned slots of the surrounding stator core. According to another non-limiting example, the round wires are wound around a mandrel, on which the wound coil is deformed into a star pattern. This coil is then pulled off of the mandrel and into the stator bore and the stator core slots. Conventional fly-winding techniques thus provide continuous conductors for a given electrical phase winding on a stator assembly.

The insertion and welding processes used in hairpin winding techniques are much slower than those used in conventional fly-winding techniques, and require more expensive tooling and equipment. Conventional fly-winding techniques are therefore preferred for their speed, low investment in tooling and facilities, and low material costs, while hairpin winding techniques are preferred for high slot fill.

Methods and systems that facilitate higher speed and efficiency, reduced costs, and achieve higher stator slot fill are desirable advancements in the relevant art, and are continually being sought.

### SUMMARY

A method, system, and stator assembly according to the present disclosure achieves a slot fill comparable to that of rectangular windings with the relatively low variable cost and investment, and higher speed, associated with conventional round wire winding techniques, and represents a desirable advancement in the art.

According to the teachings of the present disclosure, during manufacture of a stator assembly a conventional winding technique utilizing low-cost round wire is performed. As usual, the stator core is provided with a plurality of teeth, and between each pair of adjacent teeth is defined a stator slot. Here, however, the width of which approximates one conductor diameter, and the wires are arranged in single file into the slot. A compression tool in the form of a roller is run along the length of each stator slot to plastically deform and slightly flatten the round wire winding and compact it into the slot. The tip of at least one of the pair of teeth is then cold formed to at least partially close up the slot opening upon the already compacted wires, further compacting them into the slot and retaining the winding therein. Accordingly, a high slot fill stator winding is achieved at lower variable costs than previously realized using rectangular wire hairpin winding technology.

The process of compacting the wires and flattening them with a roller according to the present disclosure is facilitated by the relatively neat, stacked, single file arrangement of round wires in the slot, without resulting in problems of wire-cut through, insulation breakdown, etc., which are problems more likely to occur with prior, bulk wire winding arrangements. Indeed, the compaction process disclosed herein is not envisioned, much less expected, to work successfully in the mass production of normally bulk, fly-wound stators wherein the randomness of the wire orientations and locations in the slot allows them to cross over each other. The wires of such prior stators, if compacted according to the present disclosure, could be severed and/or the insulative insert critically damaged, which sometimes occurs to wires so installed even without compaction, undermining the likelihood of the method hereby disclosed being successfully implemented with such bulk wire windings. In accordance with the present disclosure, the slot width being approximated by one round wire diameter, with the arranged plurality of wires pressing neatly on top of one another in single file along the slot depth, facilitates the successful implementation of the compaction process.

Additionally, in a stator assembly manufactured in accordance with the present disclosure, as the wires of the arranged plurality of conductor segments flatten under the force of the roller, they expand in the circumferential slot width direction. This is a very desirable result that increases the structural rigidity of the stator core teeth, and prevents them from vibrating freely, which consequently reduces magnetic noise in the electric machine. Moreover, the deforming compaction of the windings into the stator slots, by which the wire segments are tightly pressed up against the sides of the stator slot improves the thermal conduction path between the windings and the stator core, which are in compressive engagement with each other through the electrically insulative insert material. The improved conductive heat transfer capability between the compacted conductors and the stator core lowers the operating temperature of the windings, which reduces their electrical resistance, and promotes machine efficiency and durability.

The present disclosure provides a method of manufacturing a stator assembly for an electrical machine, including the steps of: arranging a plurality of elongate wire segments in single file along the depth of a stator slot located between opposing walls of a pair of adjacent stator core teeth; compressing the wire segments substantially in a direction of the stator slot depth, whereby the wire segments are compacted into the stator slot; plastically deforming at least one of the wire segments, whereby a cross-section of the plastically deformed wire segment is expanded in a direction along which the opposing tooth walls are spaced from each other; and deforming the tip of at least one of the pair of adjacent stator core teeth to at least partially close up the stator slot upon the compressed wire segments and further compacting the wire segments into the stator slot.

A further aspect of this disclosure is that the stator core is annular and has a central axis, the stator slot depth being in a radial direction relative to the central axis. The lengths of the stator slot and each arranged elongate wire segment therein are oriented in directions generally parallel with the stator core central axis, and the compressing of the wire segments is performed progressively along the stator slot and wire segment lengths.

A further aspect of this disclosure is that the method includes expanding at least one of the compressed wire segments in directions towards the opposing walls.

A further aspect of this disclosure is that the step of arranging includes arranging along the stator slot depth a plurality of elongate wire segments each having a round cross section. An additional aspect of the disclosed method is that each of the plurality of elongate wire segments is a portion of a continuously wound conductor for a given electrical phase.

A further aspect of this disclosure is that the method includes a step of electrically insulating the stator core and the plurality of wire segments from each other. An additional aspect of the disclosed method is that the step of electrically insulating includes providing a layer of electrically insulative material in the stator slot prior to arranging the plurality of wire segments along the stator slot depth. The disclosed method may also include compressing the layer of electrically insulative material between a wire segment and the stator slot. An additional aspect of the disclosed method is that it includes expanding at least one of the compressed wire segments in directions towards the opposing walls, wherein insulative material in the stator slot is compressed during expansion of at least one of the compressed wire segments.

A further aspect of this disclosure is that deforming the tip of at least one of the pair of adjacent stator core teeth includes cold forming the tip.

A further aspect of this disclosure is that the method includes deforming the tips of both of the pair of adjacent stator core teeth to at least partially close up the stator slot upon the compressed wire segments.

A further aspect of this disclosure is that, after the step of arranging and before the step of compressing, a portion of one of the plurality of wire segments projects from the stator slot in a direction of the stator slot depth, and the step of compressing includes applying a compression tool to that one wire segment. An additional aspect of the disclosed method is that the compression tool is a roller having an axis of rotation substantially perpendicular to the length of that one wire segment, and applying the compression tool includes rolling the compression tool along the length of that one wire segment while applying compressive force in a direction substantially perpendicular to the compression tool axis of rotation with the compression tool on the arranged plurality of elongate wire segments. The disclosed method may also include, during the step of compressing, that a portion of the compression tool is disposed between the pair of adjacent stator core teeth.

A further aspect of this disclosure is that each of the arranged plurality of elongate wire segments prior to the step of compressing has a round cross-sectional shape, and at least one of the arranged plurality of elongate wire segments subsequent to the step of compressing is substantially altered from its round cross-sectional shape.

A further aspect of this disclosure is that the method includes engaging one of the plurality of arranged elongate wire segments with a compression tool, and moving the compression tool substantially in a direction along the stator slot depth. An additional aspect of the disclosed method is that it includes moving the compression tool in a direction generally perpendicular to a direction along the stator slot depth.

The present disclosure also provides a method for manufacturing a stator assembly for an electrical machine, including: providing a stator core having a pair of spaced teeth defining a stator slot therebetween, the stator slot having a length and a depth along the teeth, and a width between the teeth; disposing round magnet wire segments each of a diameter approximating the stator slot width along the stator slot length and in single file along the stator slot depth; forcing a roller against one of the wire segments in a direction of the stator slot depth while moving the roller along the direction of the stator slot length; plastically deforming at least one wire segment with the roller and expanding the deformed wire segment in the direction of the stator slot width, whereby the wire segments are compacted into the stator slot; and plastically deforming at least one of the stator core teeth to at least partially close the stator slot and further compact the wire segments into the stator slot.

A further aspect of this disclosure is that the method includes disposing insulative material into the stator slot prior to disposing the round magnet wire segments into the stator slot, the insulative material disposed between the wire segments and the stator core teeth prior to forcing the roller against one of the wire segments.

A further aspect of this disclosure is that the method includes receiving a portion of the roller between tips of the stator core teeth, and moving a portion of the wire segment against which the roller is forced from outside of the stator slot to a location inside of the slot.

The present disclosure also provides a stator assembly for an electric machine, including a stator core and a winding. The stator core has a pair of teeth defining a stator slot, and each tooth has a tooth tip. The stator slot has a length and a depth in respective directions along the teeth and a width in a respective direction along which the teeth are spaced from each other. The stator slot also has an opening and a bottom spaced along the depth direction. The winding includes a plurality of elongate wire segments disposed in the stator slot and oriented along the stator slot length direction. Each of the plurality of wire segments has a cross-sectional dimension that approximates the stator slot width, and the plurality of wire segments has a single file arrangement generally along the stator slot depth direction. At least the wire segment nearest the stator slot opening plastically deformed in-situ, the plastically deformed wire segment extending between and in compressive engagement with both of the spaced teeth. The stator slot opening is at least partially closed upon the plurality of wire segments by a deformation of at least one tooth tip.

### BRIEF DESCRIPTION OF THE DRAWINGS

The above-mentioned aspects and other characteristics and advantages of an apparatus and/or method according to the present disclosure will become more apparent and will be better understood by reference to the following description of exemplary embodiments taken in conjunction with the accompanying drawings, wherein:

FIG. 1 is a fragmented, partially cross-sectioned end view of a stator assembly in the process of being manufactured according to the present disclosure, showing a plurality of uncompacted round wire conductor segments arranged in a stator slot;

FIG. 2 is a view similar to FIG. 1, showing the arrangement of conductor segments compacted into the stator slot with a compression tool, and the conductor segment engaged by the compression tool plastically deformed;

FIG. 3 is a view similar to FIG. 1, showing the opening of the stator slot partially closed upon the conductor segments, further compacting them into the stator slot;

FIG. 4 is a partially fragmented cross-sectional side view of the stator assembly shown in FIGS. 1-3 during compaction of the arranged conductor segments with the compression tool, showing the conductor segment engaged by the compression tool being plastically deformed; and

FIG. 5 is a view similar to FIG. 1, showing forces acting on the arranged plurality of conductor segments during compaction with the compression tool shown in FIGS. 2 and 4.

Corresponding reference characters indicate corresponding parts throughout the several views. Although the drawings represent embodiments of the disclosed apparatus and method, the drawings are not necessarily to scale or to the same scale and certain features may be exaggerated or omitted in order to better illustrate and explain the present disclosure. Moreover, in accompanying drawings that show sectional views, cross-hatching of various sectional elements may have been omitted for clarity. It is to be understood that this omission of cross-hatching is for the purpose of clarity in illustration only.

### DETAILED DESCRIPTION

The following description is set forth in the context of the manufacture of polyphase, multiple-pole stators for rotary electric machines. The embodiments described below are not intended to be exhaustive or to limit the present disclosure to the precise forms or steps disclosed in the following detailed description. Rather, the embodiments are chosen and described so that others skilled in the art may appreciate and understand the principles and practices of the present disclosure.

An example stator assembly 10 resulting from a manufacturing process facilitated by and according to the system and method hereby disclosed is substantially as described above, and is be intended for use in a three-phase rotary electric machine. The stator assembly 10 includes a stator core 12 in which are located a number of stator slots 14 arranged about the stator central axis 16, with each of the stator slots 14 associated with one of the three current phases. This association progressively repeats itself in sequence around the radially inner face 18 of the stator core bore 20 which, upon completion of the process herein described, is substantially cylindrical. As is typical, the stator core 12 is formed of a stack of aligned, interconnected electrical steel laminae which define the radially inner bore face 18 and the stator slots 14, the stator slots 14 separated from one another by stator poles or teeth 22 formed by the lamina stack, and an electrically insulative insert 24 that defines the interior wall of each stator slot 14. As viewed axially, the longitudinal stator slots 14 are generally U-shaped, with approximately parallel sides 26, 28. The stator slot sides 26, 28 extend radially between a slot opening 30 located between a pair of curved shoulders 32 formed in the stator core 12 and the semi-cylindrical slot bottom 34; the depth of each stator slot 14 extends between the opening 30 and the bottom 34.

Pairs of circumferentially adjacent stator teeth or poles 22 define, between their interfacing, parallel, spaced side surfaces 36, 38, core slots 40 in the stator core 12, each core slot 40 fitted with an insulator insert 24 to define a stator slot 14 suitably designed to accommodate the radial insertion of elongate segments of copper magnet wire conductors 42 having a round cross-sectional shape into the stator slots 24 through the slot openings 30. The stator slot opening shoulders 32 are spaced by the slot opening width Wo which is slightly larger than the round wire diameter, and thus permits the wire segments 42 to be inserted radially into the stator slots 14. The circumferential spacing between the adjacent teeth 22 widen slightly radially outward of the opening 30, to the width Wc of the core slot 40, defined between the interfacing parallel sides 36, 38 of the circumferentially adjacent teeth 22. The stator winding may be prepared using any variation of a conventional technique suitable for round wire, such as a known fly-winding technique, and the conductor segments 42a, 42b, 42c, 42d are inserted either individually or as a group into their respective stator slot 14 through its opening 30.

In an imaginary plane perpendicular to the central axis 16, each stator slot 14 and core slot 40, and the common opening 30 thereto are centrally positioned about a slot radial centerline 44. The difference in widths Wc and Wo is substantially equivalent to twice the thickness t (i.e., 2t) of the electrically insulative insert 24 that lines the core slot 40 and defines the interior of the stator slot 24. The insulative insert 24 is a known, flexible, dielectric material layer having thermal properties suitable for conductively transferring heat between the conductor segments 42 and the stator core 12. As mentioned above, the insert 24 may be made of plastic sheeting, for example. As shown, each insert 24 extends continually along the perimeter of its respective core slot 40 between the slot shoulders 32. Width Wc and thickness t are such as to allow unrestricted radial insertion of the conductor segments 42 into each stator slot 14, between the stator slot walls 26, 28 defined by the interfacing, parallel surface portions of its respective insulative insert 24. Thus, the stator slot 13 has a width Ws substantially equal to width Wo (i.e., Ws=Wo=Wc−2t), and approximates the diameter of the round wire segments 42. Preferably, there is a clearance of, for example, from about 0.4 to 1.0 mm between the stator slot width Ws and the wire diameter, the clearance being comparatively much smaller than the wire diameter. Thus, a single file arrangement of the conductor segments 42, though likely not straight, is maintained along the depth of the stator slot 14, with the cylindrical surfaces 46 of the arranged wire segments 42 abutting.

As noted above, magnet copper wire having a round cross-sectional shape currently costs roughly $5/kg less than rectangular wire. Stator windings of round wire may be prepared using, for example, conventional fly-winding technology, which is well-known in the art. Such techniques are also much faster than the hairpin winding and welding processes utilized with rectangular wire. Thus, for a winding of a given copper mass, the use of round wire represents a significant comparative variable cost savings vis-a-vis rectangular wire. As also noted above, conventional fly-winding techniques are also accommodated by a relatively less expensive investment in tooling and facilities. As shown, the stator coil windings include a plurality (here, four) elongate round wire segments 42a, 42b, 42c, 42d is disposed along the depth direction in each stator slot 14, the plurality of conductor segments 42 abutting each other and arranged in a single file stack generally along the slot radial centerline 44.

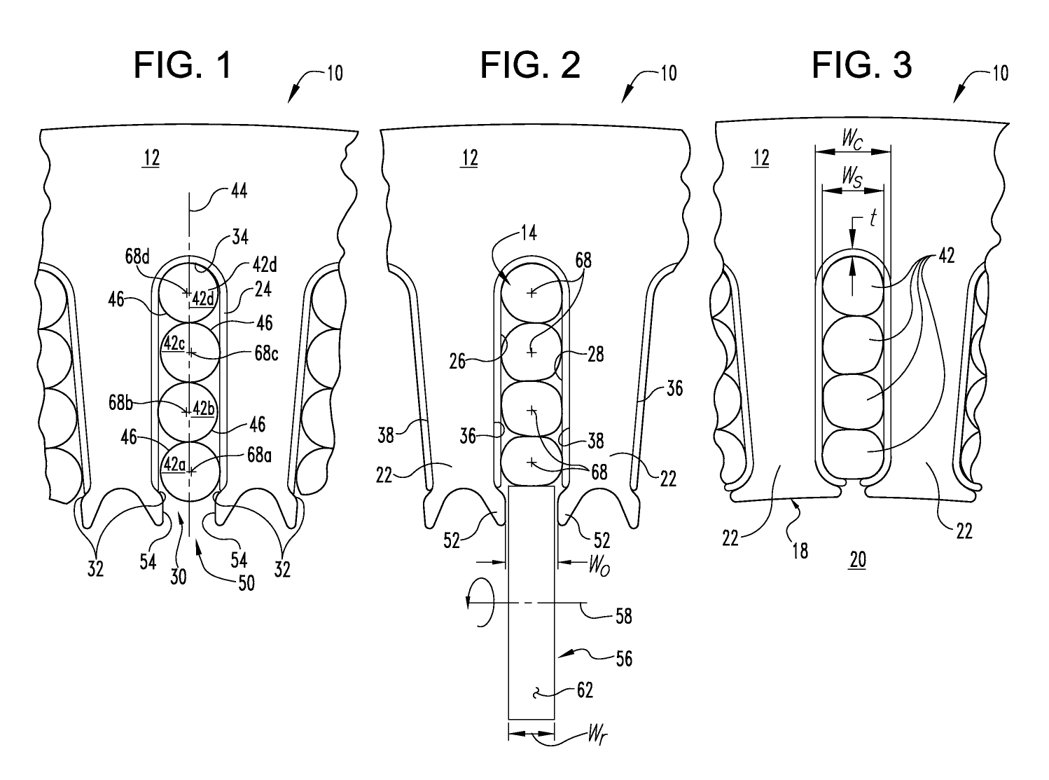

As shown in FIG. 1, once the round wire conductor segments 42 are inserted into the stator slot 14, the radially innermost portion of the radially innermost segment 42a extends slightly into the slot neck 50 located between the tips 52 of the adjacent teeth 22. The neck 50 has interfacing, parallel sides 54 spaced the distance of width Wo apart. The sizing of the slot depth between the slot bottom 34 and opening 30, and the round wire segment 42 stack up (here, four times the round wire diameter) is such that the radially innermost one of the wire segments, 42a, protrudes slightly out of the stator slot opening 30 and into the slot neck 50.

Referring to FIG. 2, a compression tool or roller 56, having a width Wr along its axis of rotation 58 that is narrower than the slot opening width Wo, is used to compact the arranged plurality of round wire segments 42 into the stator slot 14. The roller 56 is received into the neck 50 between the neck sides 54, and moves along the length of, and compressively engages, the radially innermost winding segment 42a, thereby applying a compacting force F on the arranged stack of wire segments 42 that forces them into the depth of the stator slot 14 generally along the slot radial centerline 44. The radially directed compacting force F applied on the stack of round wire segments 42 during compaction of the winding into the stator slot 14 causes plastic deformation of at least one of the conductor segments 42, i.e., the radially innermost conductor segment 42a, permanently flattening it out of its round cross-sectional shape. Upon initiation of the step of compaction the winding into the stator slot, the roller 56 can be moved radially outwardly along the slot radial centerline 44 subsequent to receipt of the roller 56 into the slot neck 50. Alternatively, prior to receipt of the roller 56 into the neck 50, the roller position along the slot depth may be established.

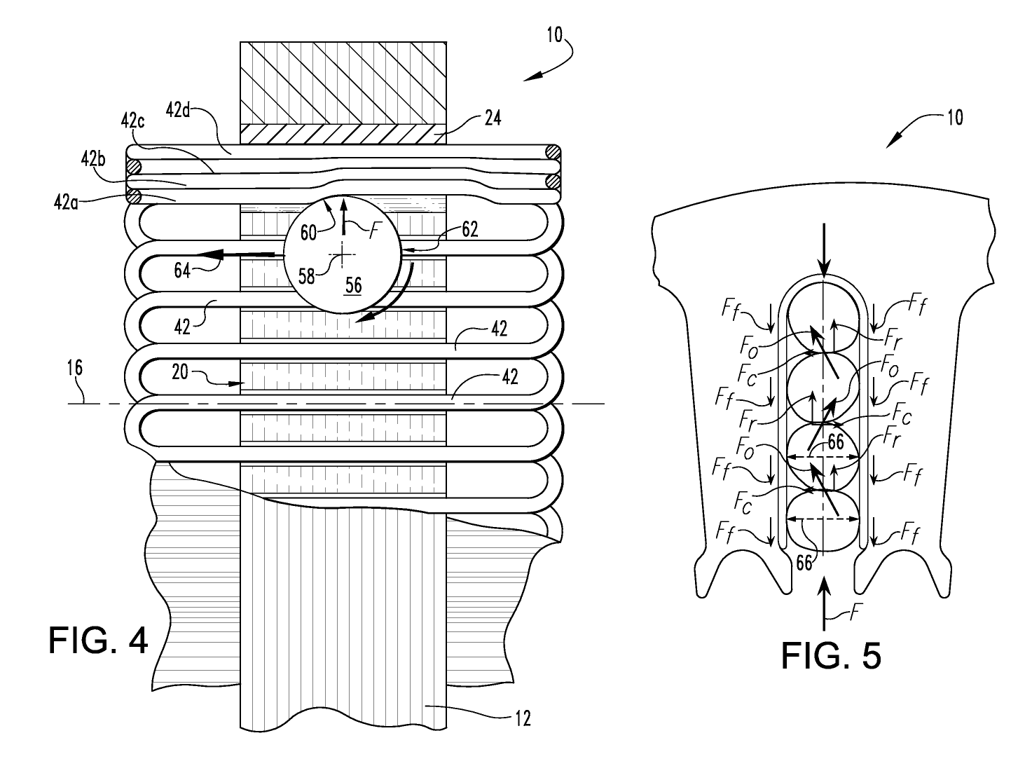

During compaction at least the wire segment 42a nearest the stator slot opening 30 is plastically deformed in-situ, i.e., within the slot 14, and the contact patch 60 between the cylindrical face 62 of the roller 56 and the segment 42a moves in the direction of the slot length. Referring to FIGS. 2 and 4, a single pass of the roller 56 along the slot length in the direction of arrow 64 may suffice for compaction of the conductor segments 42 into the stator slot 14, whereby the contact patch 60 remains at its initially established, radial distance from the central axis 16. Alternatively, a second pass of the roller 56 along the slot length, in a direction opposite to that indicated by arrow 64, may further force the winding segments 42 into the slot 14, whereby the contact patch 60 is reestablished at a subsequent radial distance farther from the central axis 16. As shown in FIG. 4, the roller 56 rolls about its axis 58 as it moves in directions along and/or opposite that indicated by arrow 64, while applying a compacting force F through the contact patch 60 to the conductors 42 arranged in the stator slot 14.

Referring now to FIGS. 2 and 5, during compaction, at least the radially innermost wire segment 42a, during its flattening plastic deformation by the roller 56, expands in circumferential directions indicated by arrows 66, in directions along which the opposing tooth walls 36, 38 are spaced from each other, towards the opposing walls 26, 28 of the stator slot 14, with the cross sectional shape of the wire segment(s) 42 being altered from their original, round shape. The diametrically opposite sides of at least deformed wire segment 42a are brought into compression with the opposing sides 26, 28 of the stator slot 14. Of the compacted plurality of wire segments 42 in a stator slot 14, at least the radially innermost segment 42a is placed in compressive engagement with the interfacing sides 36, 38 of the circumferentially adjacent stator core teeth 22 through the thicknesses of the interposed insulator insert 24. The compressive engagement between the wire segments 42 and the sides 36, 38 of the stator core teeth 22 retains the arranged wire segments 42 within the stator slot 14, at least during the remainder of the winding installation process as disclosed herein.

As noted above, the diameter of the round wire segments 42 approximates the stator slot width Ws defined between the interfacing insulator surface portions 26, 28, thereby maintaining the single file arrangement of the segments 42 along the slot depth. If the round wire segment diameter is equal to or slightly greater than the slot width Ws (the latter case resulting in the insulator 24 being slightly compressed between the wire segments 42 and the sides 26, 28 of the stator slot 14), the compacting force F imparted by the roller 56 may be transferred between the abutting conductor segments 42 in a direction substantially aligned with the slot radial centerline 44. Preferably, however, the wire diameter is slightly smaller than width Ws, which causes a slight staggering of the single file arrangement of wire segments 42 along the slot depth during compaction, if not before. In other words, at the onset of compaction, in an imaginary plane perpendicular to the central axis 16, the positions of the respective axial centerlines 68 of the adjacent wire segments 42 arranged in the stator slot 14 alternate between opposite sides of the radial slot centerline 44. To clarify by example with reference to FIG. 1, relative to slot radial centerline 44, the axial centerline 68a of conductor segment 42a is slightly to the right, centerline 68b of segment 42b is slightly to the left, and centerline 68c of segment 42c is slightly to the right. The axial centerline 68d of segment 42d located at the slot bottom 34, may be centered or slightly to the left relative to the slot radial centerline 44.

Thus, preferably, with reference to FIG. 5, the arranged wire segments 42 self-align in the stator slot 14 along the slot depth such that the compacting force F is transferred between their adjacent, abutting cylindrical surfaces 46 in direction other than parallel with the slot radial centerline 44. Consequently, the compacting force F applied by the roller 56 to wire segment 42a is transferred between adjacent wire segments 42 as oblique compacting forces Fo at angles relative to the slot radial centerline 44, rather than solely along a direction parallel with the slot radial centerline 44.

Those of ordinary skill in the art will appreciate that, in an imaginary plane perpendicular to the stator central axis 16, a radial force component Fr of the oblique compacting force Fo acting between a pair of adjacent wire segments 42, forces the radially outermost wire segment 42 further into the slot 14, whereas another, circumferential force component Fc of the oblique compacting force Fo forces the radially outermost of the pair of adjacent wire segments into compressive engagement with one of the stator core teeth 22 through the interposing layer of the insulator insert 24.

As noted above, wire segment 42a, upon which compacting force F is imparted substantially radially by the roller 56, will expand towards the interfacing walls 36, 38 of the core slot 40 defined by the spaced side surfaces 36, 38 of the respective, adjacent stator teeth 22, and brought into compressive engagement with both of the walls 36 and 38 through the insulator insert 24. The oblique force Fo, and its respective force components Fr and Fc acting between adjacent wire segments 42, diminishes from wire segment-to-wire segment as the compacting force F is transferred in the radially outward direction, due to opposing frictional force reactions Ff to radial force components Fr which are represented in FIG. 5. Consequently, the oblique compacting force Fo acting on the bottommost wire segment 42d, and the resultant deformation of that segment, may be negligible.

In other words, when the arranged wire segments 42 are stacked in the stator slot 14, they do not perfectly align on top of each other such that their point of contact with a neighboring wire segment is on the radial slot centerline 44. That is, the wire segments 42 of a respective stator slot 14 are not perfectly radially aligned along the slot depth. Rather, due to bends in and the curvature of the wire, and the clearance between the wire segments 42 and the stator slot 14, these points of contact will be slightly off center relative to the slot radial centerline 44. Thus, during wire compaction, at the interface between radially adjacent wire segments 42, generally circumferentially directed side forces Fc are created, rather than purely radially directed compaction forces Fr. These side forces Fc reduce the radial compaction forces Fr imposed on one individual wire segment 42 by another. Consequently, the wire segments 42 deeper in the stator slot 14 (i.e., relatively radially outward) will experience less of the compaction force F imparted by the roller 56 than wire segments 42 nearer the slot opening 30 (i.e., relatively radially inward), which are more directly affected by the compacting force F and more greatly deformed thereby. This in turn, lessens the probability that the radially outermost wire segment 42d at the slot bottom 34 will be electrically grounded to the stator core 12 during compaction, as might possibly occur due to splitting or crushing of the portion of the electrically insulative insert 24 located between that segment 42d and the bottom of the core slot 40.

During roller compaction, the cross-sectional shape of at least the radially innermost wire segment 42a is plastically deformed from its original round configuration, as segments 42b, 42c, and/or 42d may also be. The flattened, compacted conductor segments 42 fill voids in the stator slot 14, or spaces previously occupied by the relatively softer material of the insulator insert 24 through which the conductor segments compressively engage the walls 36, 38 of the core slot 40, causing compaction of the insulator into the core slot. Thus, cold-forming of the winding segments 42 (and the insulator insert 24) through application of the compacting force F with the roller 56, displaces segment 42a out of the slot neck 50 and compacts the arranged plurality of segments 42 completely into the stator slot 14, thereby increasing the stator slot fill relative to that which can otherwise be achieved using round magnet arranged in the slot. The slot fill achieved by the disclosed method is comparable to that which can be realized with hairpin-wound rectangular magnet wire or bar, but at substantially lower cost.

The expansion of the wire segments 42 in circumferential directions within the stator slot 14 as they flatten during compaction also desirably results in the creation of a more rigid stator tooth structure. The stator teeth or poles 22 are buttressed by the interposed, compacted conductors 42 with which they are brought into compressive engagement. This structural reinforcement of the stator teeth 22 consequently helps to reduce magnetic noise in the electric machine by preventing the teeth 22 from vibrating freely. The expansion of the wire segments 42 in the circumferential direction within the slot 14 during compaction additionally desirably results in improved thermal conduction between the conductors 42 and the stator core 12 through the electrical insulator 24. By pressing the conductor segments 42 tightly up against the sides of the stator teeth 22, the thermal conduction path between the stator coil windings and the stator core is improved, which lowers the operating temperature of the windings and reduces their electrical resistance, improving machine efficiency and durability.

Once the arranged plurality of conductor segments 42 has been initially compacted into the stator slot 14 with the roller 56, at least one, and preferably both (as shown), of the pair of stator core tooth tips 52 defining the neck 50 is plastically deformed to at least partially close the slot opening 30 on the compacted winding segments 42 therein. One or both of the tooth tips 52 is/are cold formed to at least partially close the slot opening 30, and further compact the wire segments 42 into the stator slot 14, as shown in FIG. 3. U.S. Pat. Nos. 6,278,213 and 6,742,238, the entire disclosures of which are hereby incorporated by reference, teach systems and methods which may be used for cold-forming the stator tooth tip(s) 52 to close the stator slot openings 30 upon conductor segments 42 installed in the slots 14; the teachings of these references are employed in the present disclosure. The cold-forming of the tooth tips 52 also renders the stator core bore face 18 substantially cylindrical, as shown in FIG. 3. The further compaction of the conductor segments 42 achieved through a second cold-forming operation on the tooth tip(s) 52 further increases, i.e., improves, the slot fill, tooth stability, and thermal conduction path between the windings and the stator core. Additionally, the plastic deformation of the cold-formed tooth tip(s) 52 permanently retains the wire segments 42 within the stator slot 14.

The net result is a stator assembly having a high slot fill obtained with low cost round wire and conventional winding equipment, and which, through two relatively simple cold forming processes, has its windings compacted into the stator slot 14 with the roller 56 and its tooth tip(s) 52 folded closed over the opening 30, further compacting the wire segments 42 into the stator slot 14.

While an exemplary embodiment has been disclosed hereinabove, the present disclosure is not limited to the disclosed embodiment. Instead, this application is intended to cover any variations, uses, or adaptations of the present disclosure using its general principles. Further, this application is intended to cover such departures from the present disclosure as come within known or customary practice in the art to which this present disclosure pertains and which fall within the limits of the appended claims.

What is claimed is:

1. A method of manufacturing a stator assembly for an electrical machine, comprising the steps of:
arranging a plurality of elongate wire segments in single file along the depth of a stator slot located between opposing walls of a pair of adjacent stator core teeth;
compressing the wire segments substantially in a direction of the stator slot depth, whereby the wire segments are compacted into the stator slot;
plastically deforming at least one of the wire segments, whereby a cross section of the plastically deformed wire segment is expanded in a direction along which the opposing tooth walls are spaced from each other; and
deforming the tip of at least one of the pair of adjacent stator core teeth to at least partially close up the stator slot upon the compressed wire segments and further compacting the wire segments into the stator slot.

2. The method of claim 1, wherein the stator core is annular and has a central axis, the stator slot depth being in a radial direction relative to the central axis, the lengths of the stator slot and each arranged elongate wire segment therein being oriented in directions generally parallel with the stator core central axis, and the compressing of the wire segments is performed progressively along the stator slot and wire segment lengths.

3. The method of claim 1, wherein the step of arranging includes arranging along the stator slot depth a plurality of elongate wire segments each having a round cross section.

4. The method of claim 3, wherein each of the plurality of elongate wire segments is a portion of a continuously wound conductor for a given electrical phase.

5. The method of claim 1, further comprising a step of electrically insulating the stator core and the plurality of wire segments from each other.

6. The method of claim 5, wherein the step of electrically insulating includes providing a layer of electrically insulative material in the stator slot prior to arranging the plurality of wire segments along the stator slot depth.

7. The method of claim 6, further comprising compressing the layer of electrically insulative material between a wire segment and the stator slot.

8. The method of claim 5, further comprising expanding at least one of the compressed wire segments in directions towards the opposing walls, and wherein insulative material in the stator slot is compressed during expansion of at least one of the compressed wire segments.

9. The method of claim 1, wherein deforming the tip of at least one of the pair of adjacent stator core teeth includes cold forming the tip.

10. The method of claim 1, further comprising deforming the tips of both of the pair of adjacent stator core teeth to at least partially close up the stator slot upon the compressed wire segments.

11. The method of claim 1, wherein after the step of arranging and before the step of compressing a portion of one of the plurality of wire segments projects from the stator slot in a direction of the stator slot depth, and the step of compressing includes applying a compression tool to that one wire segment.

12. The method of claim 11, wherein the compression tool is a roller having an axis of rotation substantially perpendicular to the length of that one wire segment, and applying the compression tool includes rolling the compression tool along the length of that one wire segment while applying compressive force in a direction substantially perpendicular to the compression tool axis of rotation with the compression tool on the arranged plurality of elongate wire segments.

13. The method of claim 12, wherein during the step of compressing a portion of the compression tool is disposed between the pair of adjacent stator core teeth.

14. The method of claim 1, wherein the each of the arranged plurality of elongate wire segments prior to the step of compressing has a round cross-sectional shape, and at least one of the arranged plurality of elongate wire segments subsequent to the step of compressing is substantially altered from its round cross-sectional shape.

15. The method of claim 1, further comprising engaging one of the plurality of arranged elongate wire segments with a compression tool, and moving the compression tool substantially in a direction along the stator slot depth.

16. The method of claim 15, further comprising moving the compression tool in a direction generally perpendicular to a direction along the stator slot depth.

17. A method for manufacturing a stator assembly for an electrical machine, comprising:
providing a stator core having a pair of spaced teeth defining a stator slot therebetween, the stator slot having a length and a depth along the teeth, and a width between the teeth;
disposing round magnet wire segments each of a diameter approximating the stator slot width along the stator slot length and in single file along the stator slot depth;
forcing a roller against one of the wire segments in a direction of the stator slot depth while moving the roller along the direction of the stator slot length;
plastically deforming at least one wire segment with the roller and expanding the deformed wire segment in the direction of the stator slot width, whereby the wire segments are compacted into the stator slot; and
plastically deforming at least one of the stator core teeth to at least partially close the stator slot and further compact the wire segments into the stator slot.

18. The method of claim 17, further comprising disposing insulative material into the stator slot prior to disposing the round magnet wire segments into the stator slot, the insulative material disposed between the wire segments and the stator core teeth prior to forcing the roller against one of the wire segments.

19. The method of claim 17, further comprising receiving a portion of the roller between tips of the stator core teeth, and moving a portion of the wire segment against which the roller is forced from outside of the stator slot to a location inside of the slot.

20. A stator assembly for an electric machine, comprising:
a stator core having a pair of teeth defining a stator slot, each tooth having a tooth tip, the stator slot having a length and a depth in respective directions along the teeth and a width in a respective direction along which the teeth are spaced from each other, the stator slot having an opening and a bottom spaced along the depth direction; and
a winding comprising a plurality of elongate wire segments disposed in the stator slot and oriented along the stator slot length direction, each of the plurality of wire segments having a cross-sectional dimension that approximates the stator slot width, the plurality of wire segments having a single file arrangement generally along the stator slot depth direction, at least the wire segment nearest the stator slot opening plastically deformed in-situ, the plastically deformed wire segment extending between and in compressive engagement with both of the spaced teeth, the stator slot opening at least partially closed upon the plurality of wire segments by a deformation of at least one tooth tip.
